(19) United States
(12) Patent Application Publication
(10) Pub. No.: US 2001/0049609 A1
(43) Pub. Date: Dec. 6, 2001

(54) System for assisting wound treatment management

(76) Inventors: Michael Girouard, San Antonio, TX (US); Michael Wells, San Antonio, TX (US); David G. Kessler, Cherry Hill, NJ (US); Kathleen Thimsen, Maple Shade, NJ (US)

Correspondence Address: KCI, 4958 Stout Drive, P.O. Box 659508, San Antonio, TX, 78265-9508, US

(21) Appl. No.: 09/803,569

(22) Filed: Mar. 9, 2001

Related U.S. Application Data
(60) Provisional application No. 60/187,978, filed on Mar. 9, 2000.

(51) Int. Cl. G06F 17/60; G06F 17/30

(52) U.S. Cl. 705/3; 705/2; 707/104.1

(57) ABSTRACT

A system for improving wound treatment data management has been developed. The system evaluates relevant wound and patient characteristics to generate a proposed treatment routine. The system also evaluates the ongoing treatment of the wound and may generate alarm output, suggestions to health care providers, or proposed modifications to the treatment routine. In addition, the invention may also generated automated orders for such items as consumable treatment components. The system may also be used to evaluate financial considerations and implications of both initial and modified treatment routines.

### RELATED APPLICATION INFORMATION

This application claims priority from commonly owned co-pending provisional application Ser. No. 60/187,978, filed Mar. 9, 2000.

### TECHNICAL FIELD OF THE INVENTION

This invention relates generally to automated methods and data systems relating to treating wounds and managing wound treatment. More particularly, this invention relates to a computerized process for managing data, and generating output, relating to wound treatment.

### BACKGROUND OF THE INVENTION

Modem medicine engages in an ongoing search to determine which methods do, and do not work in treating various afflictions. However, this search often results in increased health care costs. In the old cost reimbursement paradigm, there were few direct controls on health care costs.

In the past few decades, however, the United States government, local and state governments, governments worldwide, and private health care organizations, have been engaged in an aggressive campaign to reduce health care costs, purportedly without adversely affecting the quality of patient care. After waste, fraud, and abuse have been reduced or eliminated, a prime means of securing such divergent goals is through increased treatment efficiency. One particularly attractive target for such efforts is more efficient wound treatment and management.

As the population median age increases, as life expectancies also increase, and as successful treatment of previously life threatening conditions also improves at least in the industrialized world, the percentage of health care recipients who are immobilized or otherwise confined has increased and likely will continue to increase.

In prior generations people rarely lived long enough, or were rarely hospitalized for a sufficiently long period of time, for chronic wounds to become a treatable health care problem, or to consume a significant amount of health care resources. It has been said that the manifest change of the last half of the 20^{th} century is that family reunions now take place at home, instead of at the cemetery.

While health care and medicine have advanced, chronic care issues consume a significant, and growing amount of resources. How to treat these conditions, and how to best use, and thereby minimize the resources expended on these issues is a problem worthy of serious attention, and ultimately, solution.

This is not to suggest that attention has not previously been paid to this problem. There has always been a serious need for efficient wound treatment. Treatment protocols, formularies, and the like, have often been used and applied in an ad hoc and even a systematic basis. However, without the requisite supporting software, such tools have been based on guesswork, educated, well meaning, and the best possible, guess work, but guess work all the same. Further, without the presently available data processing capabilities, real time, or close to real time updates and revisions of treatment data were not practical, even if theoretically possible. The possible increases in efficiency, and quality of patient care, which could result from the implementation of such a process range from the material to the enormous.

While a paramount need exists for an automatically updated and adaptive method for providing data to assist both the treating of wounds, and monitoring the success of treatments applied thereto, no such prior art process is known to exist. The fulfillment of this, and related needs is a basic goal of the present invention.

### BRIEF DESCRIPTION OF THE INVENTION

In brief, the present invention is directed towards an automatically adaptive wound treatment data processing system. The system suggests consistent treatment for specific types and severities of wounds, while accounting for individual patient characteristics. Relevant patient sub-populations may be selected from the total population of patients assisted by this system.

The system of the present invention matches specific degrees of severity, for each wound type, with corresponding levels of formulary, protocol, and utilization management. The system first receives data that identifies a wound's type. Then the system receives data that assesses wound severity.

After evaluating a wound's type and severity, patient characteristics are then evaluated. Preferably, these patient characteristics include the dimensions and conditions of the individual patient. The system next generates a proposed treatment routine, for the type of severity of the wound concerned, while accounting for patient characteristics. Treatment routines may be determined by comparing the data gathered for wound type, wound severity, and patient characteristics with a template, or a plurality of templates, that references a pre-devised treatment routine, for each combination of wound and patient data.

The present invention also re-determines proposed treatment needs, for the type and severity of the wound concerned, while accounting for patient characteristics, during the ongoing treatment process. Preferably, the periodicity of wound reassessment relates to the increments of treatment routine components that are distributed. Reassessment continues, as needed, until the wound is healed.

During reassessment, wound data is compared with previously established standards and reference values, commonly also known as benchmarks, for healing progress. Once a wound is healed, the present invention documents a treatment history, and the results reached by any treatment routines that were devised for the patient; a software program may also save the data in a database and also produces a written version of the information.

Accordingly, a prime object of the present invention is to provide an improved computerized system for wound treatment data and wound treatment management data.

Another object of the present invention is to provide an improved system for generating proposed routines for treating wounds; the system includes the step of reassessing the treatment provided to a patient pursuant to a routine or protocol, and adjusting treatment protocols in partial reliance upon this reassessment.

A further object of the present invention is to provide an improved process that includes the steps of disseminating patient treatment outcomes.

A still further object of the present invention is to provide a process that selects relevant patient sub-populations from the total patient population treated by the process.

Yet another object of the present invention is to provide a process that adapts treatment guidelines based upon the treatment experience applied to a given patient sub-population.

A yet further object of the present invention is to provide improved processes, which, over time, adjust treatment recommendations to patient populations and subpopulations based upon the actual experience of the afflicted patients being treated by the process.

These and still further objects as shall hereinafter appear are readily fulfilled by the novel process of the present invention in a remarkably unexpected manner as will be readily discerned from the following detailed description of exemplary embodiments thereof especially when read in conjunction with the accompanying drawings in which like steps bear like numerals throughout the several views. The drawings offered herein are intended to be illustrative, and are not intended to in any way limit the scope of the present invention, or the following written description.

### BRIEF DESCRIPTION OF THE DRAWINGS

FIG. 1 is a block diagram illustrating one embodiment of the present invention.

FIG. 2 is a block diagram illustrating another embodiment of the present invention.

### DESCRIPTION OF THE PREFERRED EMBODIMENTS

The present invention teaches a multi-step automated wound treatment system. This system, using data which may be in analog, digital, alphameric, some other format, or a combination thereof, selects, and generates output containing consistent treatment methods for specific types and severities of wounds, while accounting for individual patient characteristics, and, if desired, patient sub populations, to the extent that membership in a patient sub-population is clinically significant. In another embodiment of the invention, financial data may also be input, compared, evaluated, and comprise output generated thereby, in total or in part.

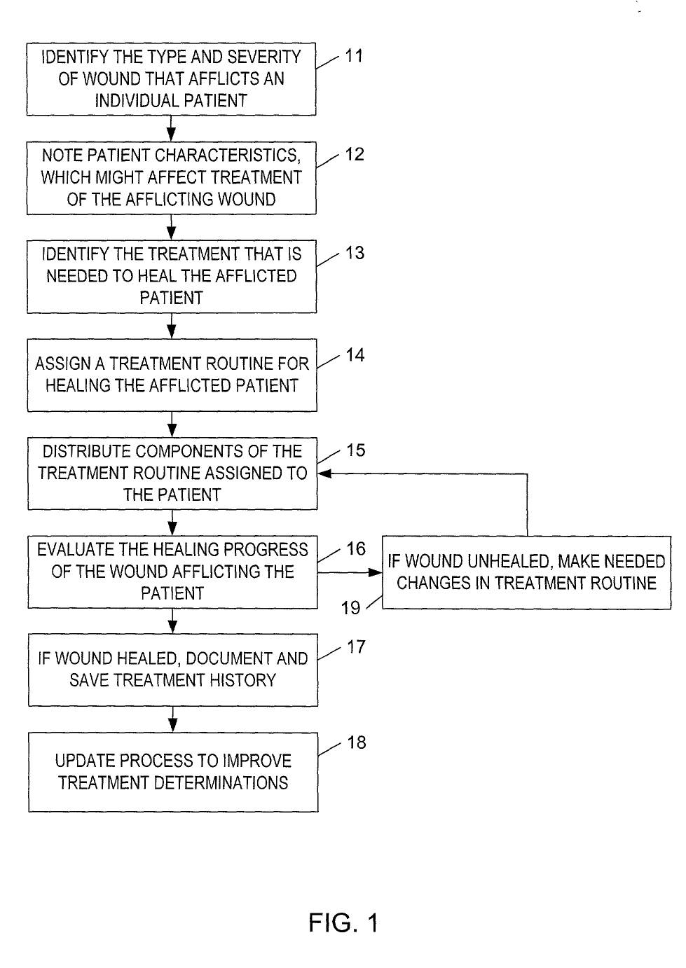

In brief, as shown in FIG. 1, the process of this preferred embodiment matches specific criteria for relevant values, such as degrees of severity, wound type, and relevant patient characteristics, for each wound type, with corresponding levels of formulary, protocol, and utilization management. The steps and activities comprising the process include assessing wound characteristics 11 assessing patient characteristics 12; identifying treatment routines 13, generating and proposing treatment routines 14 designating necessary components and procedures for treatment routines; estimating time and cost for treatment routines; directing the distribution of treatment routine components 15; monitoring wound healing progress 16; adjusting treatment routines, as necessary 19; directing distribution of components for adjusted treatment routines; documenting the treatment history and results for each patient's wound 17; and updating treatment routines for each type and severity of wound that is addressed by the process 18. This updating would, as needed, be directed towards either the entire population, or relevant sub-populations, as may be either necessary or desirable.

The system comprising the present invention involves several steps. The first step of the process employed by the invention is the classifying of a wound's type. The wound type may be classified, for example, according to the area of the afflicted patient's body that is affected by the wound. The body areas that are affected by some wound types may include the trunk, neck, or head areas. Some wound types that affect the head may affect, for example, the face or ear. The body areas that are affected by other wound types may include the extremities. Some wound types that affect the extremities may affect, for example, a hand or a foot. Some wound types that affect the foot may affect, for example, the heel area or toes. Some wound types that affect the hand may affect, for example, the wrist or the fingers. A wound type may also be classified by its location, relative to the front or back of the afflicted patient's body.

Thus, a wound may be identified by its location on the front, back, left side, or right side, of the body area that the wound affects. The wound type may also be identified by its actual effect on the area of the body, which bears the wound. Effects may be chronic or isolated. Some wound types may also affect an area of the body internally. Examples of these wound types include, among others, venal and muscular wounds. Other wound types may affect an area of the body externally. These wound types may affect, for example, the dermal layers of a body area. Examples of wound types that affect a body area externally include, among others, sores and ulcers.

In this presently preferred embodiment of the present invention, this classification process may be done through pattern classification, or by a logical tree process. The preferred embodiment of the present invention is a software program that comprises evaluating some or all of the following input data components to assess wound type, when relevant: the effect of a wound on the patient's body, the body area that is affected by the wound, and the location of the wound on the body area, relative to the front of the body.

Once the invention has assessed the wound type, it assesses the severity of the wound. The process assesses wound severity, by measuring a plurality of input wound characteristics. These characteristics may take the form of data points. Preferably, the characteristics are a plurality of data points, which include a wound's dimensions and sensory characteristics. More preferably, the data points used in determining wound's severity also describe advancement of the wound, the condition of the skin in the wound area, wound drainage, and periwound properties. The use of discrete data points would facilitate the use of pattern recognition algorithms, as well as tree analysis.

In this preferred embodiment of the present invention, a computer software program uses the following data points to determine wound severity, to wit, length, depth, tunneling, and base color of the wound compared to, or adjusted for, the surrounding skin color, as is well known in the are; wound stage—known to those skilled in the art—insofar as it may be measured in a specific case; the condition of the wound edge; the wound's necrotic amount, or percentage; type, amount, color and odor of wound drainage; the condition color and edemic qualities of the periwound area; and induration and granulation.

In the preferred embodiment of the invention, the software program compares a wound's measurements, for the above data points, to a template of combinations. This template could again comprise a “look up table” a “logical tree” or, if pattern recognition is used, a “pattern library.” Each potential combination references a hierarchy of wound severity designations, or grades. The process thereafter assigns an alphameric severity grade to the wound. If desirable, the process known to those skilled in the art as fuzzy logic may also be employed.

Upon measuring a wound's type and severity, patient characteristics are noted. Preferably, noted patient characteristics include the dimensions and conditions of the individual patient. Most preferably, those characteristics are noted, which could affect the success of a treatment routine for the type and severity of the wound, from which the patient suffers. In this preferred embodiment of the present invention, a software program notes input data concerning a patient's weight, and any diseases and allergies, from which the patient suffers. The patient is also assigned a score, using the Braden Scale, which is known to those skilled in the art. The software program then flags, or issues output alarms, if appropriate, patient characteristics, that could affect treatment of a wound having the type and severity previously determined by the software program from the data previously input into the program.

This system next determines a course of proposed treatment. This treatment is selected after making allowance for the type and severity of the wound concerned, while considering patient characteristics. Treatment needs may be determined; by comparing the data gathered for wound type, wound severity, and patient characteristics, with a template, or a plurality of templates, that references a pre-devised treatment routine, for each combination of wound and patient data.

This system also assesses a patient's wound type, and the severity, based on benchmark measurements for the data points that were discussed previously. The process also flags patient characteristics relevant to treating a wound of the type and severity grade determined. The system selects a treatment routine most appropriate to the patient's combination of wound type, severity grade, and flagged characteristics. The process then generates output including a proposed treatment routine for the individual patient's wound.

The selected proposed treatment routine comprises a plurality of elements. The treatment routine may designate, for example equipment, substances, and personnel, needed to successfully treat the wound hopefully to a healed state. An example of a healed state is closure of a tissue wound. Preferably, the routine also estimates a time for the wound to reach a healed state, under the treatment routine. More preferably, the treatment routine also estimates the cost, average cost, and/or range of cost, for the treatment routine. In the preferred embodiment of the present invention, treatment routines designate equipment necessary for treatment; accelerated healing devices, including adjunctive or compressive therapeutic devices, therapeutic surfaces, any necessary dressings including advanced dressings; any necessary substances, such as antibacterials or cleansers; necessary consulting personnel, such as ET nurses or other consulting medical professions; necessary nutrition regimens; necessary treatment procedures and protocols; and time and cost estimates, for the treatment routine that is devised.

Once the invention has selected a treatment routine for the individual patient's wound, and the health care provider has determined the treatment routine to be followed, the process directs the distribution of treatment routine components, for the routine actually followed. The invention may direct in-house or outsourced distribution of necessary supplies to the patient or the patient's medical treatment provider. The invention may direct a distributor to ship treatment components directly to the receiving party, or it may direct persons to deliver the components without shipping. The invention may also generate output suggesting medical professionals to consult in the treatment of the patient's wound. Preferably, the system will direct the distribution of treatment components, in increments that allow a treatment routine to be adjusted, if necessary, with minimal waste of personnel and treatment supplies. More preferably, the system will direct distribution of treatment routine components, in amounts projected for use within a two to six (2-6) week incremental period. Most preferably, the invention will direct the distribution of treatment routine components, in two to four (2-4) week increments. In the preferred embodiment of the present invention, a software program directs distribution of treatment routine components, in two (2) week increments.

The present invention process also monitors the treatment of individual patients, by methods including the reassessment of wound conditions. Preferably, the periodicity of wound reassessment conform to the incremental treatment routine components that are distributed, after due allowance for supply chain issues. Reassessment continues, until the wound is healed, or a stable unhealed condition from which no further progress can be procured, is reached. During reassessment, wound data are compared with benchmarks for healing progress. Preferably, the data used are similar to the data gathered for the initial wound severity determination, above.

If the patient's wound meets or exceeds the benchmarks that are used by the invention to monitor healing progress, and absent the input of data indicating that the selected treatment routine has been changed, then the system will continue to direct the distribution of treatment routine components, as designated for the initial treatment routine. If the patient's wound does not meet or exceed the benchmarks for healing progress, the system will devise a new or adjusted proposed treatment routine for the patient's wound. The system will then upon the implementation of a revised or different treatment routine, designate distribution of new treatment components to the patient, or to the patient's treatment provider, in conformance therewith. Preferably, the system will also use benchmarks to determine when output suggesting that a medical professional should consult with the patient and/or the patient's treatment provider, to adjust the treatment routine for the patient's wound, should be generated. More preferably, the system will also suggest that medical professions consult, in necessary cases.

In this preferred embodiment of the present invention, wound reassessment data is compared to a set of healing progress indicators, that benchmark healing progress for the type and severity grade of the wound being treated, after consideration of the afflicted patient's characteristics. The system determines if the wound is healing, as estimated in the initial treatment routine. If so, then the system continues to direct distribution of treatment routine components, in the increments used for the treatment routine. If not, then the process may use the wound reassessment data to select a new proposed treatment routine. The new proposed routine may be a modification of the treatment routine that was initially devised. The preferred embodiment of the present invention system will also identify outliers—patients, whose wounds continuously to fall below healing progress benchmarks, often set at 2 standard deviations on a single sided normal distribution test. In these cases, the process will generate an alarm, or other suitable output, and notify a medical professional, that consultation with the patient or the patient's treatment provider, about treatment of the specific wound, is suggested.

Once a wound is healed, the system documents a treatment history, and the results reached by any treatment routines that were devised for the patient. In the preferred embodiment, the invention saves the data in a database and also produces a written version of the information.

Treatment histories and results are used to update and improve the treatment routines that correspond to each combination of wound type, wound severity grade, and patient characteristics. Updating results in distributing more effective treatment routine components to patients and their treatment providers, and updating produces more accurate time and cost estimates for wound treatment. Preferably, the process will update treatment routines, as the amount of data warrants reasonable certainty that the treatment routines should be changed or improved. In the preferred embodiment of the invented system, a software program updates treatment routines periodically, most commonly annually. In an alternative embodiment, persons may examine a database of treatment histories and results, and reprogram suggested treatment routines in the software program.

Exemplary methods of data handling were discussed above. The data could be input through key boards, light pencils voice, scanning, CD-ROM or any other media now known, or to be developed in the future in the rapidly evolving computer science art, and still be within the spirit of the present invention. The data likely is placed on a mass storage device, manipulated by a microprocessor, processed, compared, and evaluated. The data generated by the system, for implementation in the process of suggesting the treatment of the afflicted patient are similarly generated in machine readable, and likely also, human intelligible form.

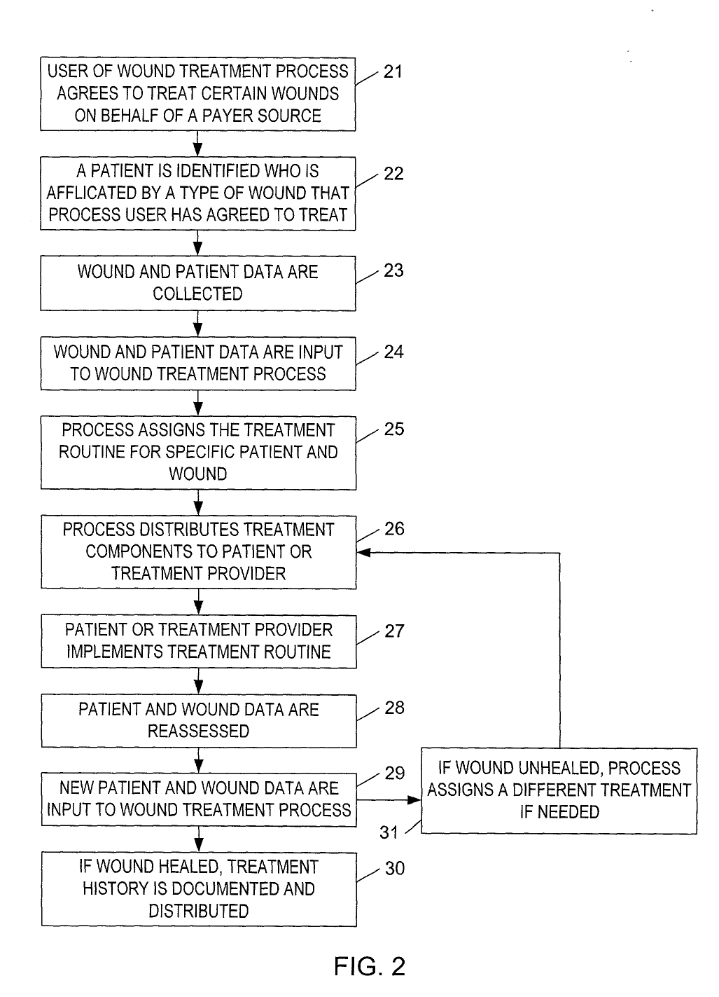

The present invention is also directed to a method of using an automated wound treatment management system. This embodiment of the method of the present invention provides the advantage of predicting and managing cost risks associated with wound treatment. Another advantage of the method is that it requires no implementation resources or start-up costs to be expended by the health care provider. This embodiment of the method of the present invention, as shown in FIG. 2, in brief, involves buying the risk of treating patients with certain wound types, from a payer source that manages wound treatment 21; recognizing patients with the wound types addressed by the automated wound treatment process 22; measuring wound data 23; inputting the measurements to the automated process 24; receiving 25 and suggesting the implementation of by a health care professional, the treatment routine suggested by the process 26, 27; reassessing the wound 28 and inputting reassessment data to the automated process 29; modifying the proposed treatment routine 31, as suggested by the automated process; and forwarding treatment history and result to the payer source 30.

The first step of this method is for the user of the automated system, the treating entity, to buy the risk of treating types and severities of wounds that are addressed thereby. Potential payer sources may include, among others, Medicare, managed care organizations (MCOs), skilled nursing facilities, integrated delivery networks, or home health care agencies. These paying agencies thereby, in exchange for paying compensation to the treating entity, have insulated themselves from the risk of adverse outcomes, which risk is now borne by the treating entity. In this preferred embodiment of the invention, the payer source maintains medical treatment personnel and designates patient care sites where the automated treatment assistance system will generate output that is to be conveyed to the treating health care providers.

The next step in this method is to identify a patient, who is, or will be located at a designated patient care site, who bears a type of wound that is addressed thereby. When such a patient is identified, the patient's wound is assessed. Preferably, medical personnel assess the wound, by measuring pre-determined data points that relate to wound characteristics. Most preferably, medical personnel of the payer source assess wound type, wound severity, and notable patient characteristics, by measuring the data points described previously. In the preferred embodiment of the invented system, payer source medical personnel measure data points, which are used by a software program, to assess wound type, grade wound severity, and flag patient characteristics.

Next, the measurements for each data point must be input to the automated process. They may be input manually. Some or all of this data may be digital, analog, alphameric, or a combination thereof. Preferably, they are input, by using a form that the automated system can interpret. In the preferred embodiment of the invention, data measurements and patient information are recorded on a teleform, which is faxed to a computer that bears a software program that uses the data to assess wound type, grade wound severity, and flag relevant patient characteristics.

After the data are input, the system selects a proposed treatment routine for the specific patient's wound, as disclosed in the description of the invention. Once the system is informed that a health care provider has implemented a treatment routine, the system distributes necessary treatment routine components, as previously described. The patient or the patient's treatment provider then implements the treatment routine pursuant to the orders of a health care professional, utilizing the automated component ordering and distribution method described above.

Once the treatment routine is implemented, wound conditions are reassessed, until the wound is healed. Wound conditions are reassessed, by measuring data points that are designated by the process, as healing indicators. The data may be input to the system manually. Preferably, these data are input in a form that the process can interpret. In the preferred embodiment of the invented method, the data are input to the automated process, using a teleform.

During the course of treatment, the invention may generate new proposed treatment routines for healing the individual patient's wound. New treatment routines may include modifications of the initial treatment routine, or consults with other medical professionals. If the treating health care professional implements the proposed modified treatment routine, components of new treatment routines will be distributed to the patient or treatment provider. The patient or treatment provider implements the changes to the initial treatment routine, until the wound is healed.

Once a treatment routine ends, the system will document the treatment history and the results of all treatment routines devised for the specific patient's wound. The history and result are distributed to the payer source. In the preferred embodiment of the invented method, a software program prints the information and directs its distribution to the payer source that is specified for the patient who was treated.

The preceding detailed description is intended to illustrate the formation and use of the invented process and is not meant to be limiting to the specific preferred embodiment described. Those individuals who are skilled in the art will recognize that changes may be made to certain details of the invention disclosed above without altering the invention itself, or departing from its scope. In particular, the above described processes may utilize the mathematical logical tool commonly known as fuzzy logic in the decision making portion of these processes.

Accordingly, the following is claimed:

1. An automated data processing system comprising the steps of:
comparing patient characteristics with a patient data set and obtaining a result therefrom;
comparing wound characteristics with a wound characteristics data set and obtaining a result therefrom; and
comparing said patient characteristic result and said wound characteristic result with indicia connected to a library of treatment routines to generate a proposed treatment routine.

2. A system according to claim 1 comprising also establishing intermediate treatment goals for a selected treatment routine for said wounds of said patient.

3. A system according to claim 2 also comprising comparing wound characteristics subsequent to the commencement of said treatment routine to said intermediate treatment goals.

4. A system according to claim 3 comprising also establishing alarm limits relating to said intermediate treatment goals.

5. A system according to claim 4 wherein said alarm limits are set at medically meaningful levels.

6. A system according to claim 4 wherein the activation of an alarm limit generates a desired data output.

7. A system according to claim 1 wherein the selection of a treatment routine generates a desired data output.

8. An automated data processing system comprising the steps of:
comparing patient characteristics with a patient data set and obtaining a result therefrom;
comparing wound characteristics with a wound characteristics data set and obtaining a result therefrom;
comparing said patient characteristic result and said wound characteristic result with indicia connected to a library of treatment routines to generate a selection of proposed treatment routines;
evaluating the selected proposed treatment routines in relation to selected criteria;
and generating output wherein said proposed treatment routines are ranked in relation to said criteria

9. A system according to claim 8 wherein said criteria may be adjusted

10. A system according to claim 8 wherein said criteria may be given different weightings

11. A system according to claim 10 wherein said weightings may be selectively adjusted.

12. A system according to claim 9 wherein said criteria may be given different weightings

13. A system according to claim 12 wherein said weightings may be selectively adjusted.

14. A system according to claim 12 wherein an intermediate treatment goal for a selected treatment routine for said wounds of said patient is created.

15. A system according to claim 14 wherein wound characteristics obtained after start of said treatment routine are compared to said intermediate treatment goal.

16. A system according to claim 15 wherein an alarm limit relating to said intermediate treatment goals is established.

17. A system according to claim 16 wherein the activation of an alarm limit generates a desired data output

18. A system according to claim 9 wherein financial criteria may also be input and financial output may be generated.

19. An automated data processing system comprising the steps of:
comparing patient characteristics with a patient data set and obtaining a result therefrom;
comparing wound characteristics with a wound characteristics data set and obtaining a result therefrom;
updating said data sets with more recent data as desired thereby creating current data sets;
determining the most current data set for data;
updating the patient data result using the most current patient data set;
updating the wound characteristic result using the most current wound data set;
comparing said patient characteristic result and said wound characteristic result with indicia connected to a library of treatment routines to generate a selection of proposed treatment routines;
evaluating the selected proposed treatment routines in relation to selected criteria;
generating output wherein said proposed treatment routines are ranked in relation to said criteria.

20. A system according to claim 19 wherein
an intermediate treatment goal for a selected treatment routine for said wound of said patient; and
comparing wound characteristics subsequent to the commencement of said treatment routine to said intermediate treatment goal; and
generating output if said intermediate treatment goal is not met.
